(19) United States
(12) Patent Application Publication
(10) Pub. No.: US 2026/0369776 A1
(43) Pub. Date: Nov. 19, 2026

(54) BATTERY PACK FRAME, BATTERY PACK INCLUDING THE SAME, AND ELECTRIC VEHICLE

(71) Applicant: SAMSUNG SDI CO., LTD., Yongin-si (KR)

(72) Inventors: Martin BLODER, Sinabelkirchen (AT); Thomas BURKE, Söding (AT)

(21) Appl. No.: 19/443,165

(22) Filed: Jan. 8, 2026

(30) Foreign Application Priority Data
May 14, 2025 (EP) 25176253.0

(51) Int. Cl. H01M 50/242; H01M 10/613; H01M 10/6554; H01M 50/249; H01M 50/271; H01M 50/291; H01M 50/367

(52) U.S. Cl. CPC H01M 50/242; H01M 10/613; H01M 10/6554; H01M 50/249; H01M 50/271; H01M 50/291; H01M 50/367

(57) ABSTRACT

A battery pack frame includes a top plate configured to frame accommodation chambers for accommodating rechargeable battery cells, wherein the accommodation chambers are delimited by intersecting lengthwise beams and crosswise beams formed by the top plate; a bottom plate positioned below the top plate; a cell cooler enclosed by the top plate and the bottom plate for cooling the rechargeable battery cells, wherein the cell cooler includes sections and voids between the sections; and a foam substantially filling a space between the top plate and the bottom plate, wherein the foam extends through the voids of the cell cooler. A battery pack includes a battery pack frame; rechargeable battery cells accommodated within the battery pack frame; and battery pack frame covers for covering the accommodation chambers of the battery pack frame. Additionally, an electric vehicle includes the battery pack.

### CROSS-REFERENCE TO RELATED APPLICATION

The present application claims priority to and the benefit of European Patent Application No. 25176253.0, filed on May. 14, 2025, in the European Patent Office, the entire disclosure of which is incorporated herein by reference.

### BACKGROUND

### 1. Field

Embodiments of the present disclosure relate to a battery pack frame configured to improve mechanical load transfer and distribution as well as energy absorption, a battery pack including the battery pack frame, and an electric vehicle including the battery pack.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable (or secondary) batteries. An electric vehicle may be solely powered by batteries (a so-called Battery Electric Vehicle or BEV) or may include a combination of an electric motor and, for example, a conventional combustion engine (a so-called Plugin Hybrid Electric Vehicle or PHEV). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows movement of ions during charging and discharging of the battery cell. The electrode assembly is located (or accommodated) in a casing and electrode terminals, which are positioned on the outside of the casing, establish an electrically conductive connection to the electrodes of the electrode assembly. The casing may have, for example, a cylindrical or rectangular shape.

A battery module is formed of a plurality of battery cells connected together in series or in parallel. For example, the battery module is formed by interconnecting the electrode terminals of the plurality of battery cells in a number and/or configuration depending on a desired amount of power and to realize a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected in series to provide a desired voltage.

A battery pack is a set of any number of (usually identical) battery modules or single battery cells. The battery modules, and respectively the battery cells therein, may be configured in a series, parallel, or a mixture of both to provide the desired voltage, capacity, and/or power density. Components of a battery pack include the individual battery modules and the interconnects, which provide electrical conductivity between the battery modules.

The mechanical integration of a battery pack requires appropriate mechanical connections between the individual components, e.g. of battery modules, and between them and a supporting structure of the vehicle. These connections must remain functional and safe during the average service life of the battery system. Further, installation space and interchangeability requirements must be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors such as bolts or screws. Alternatively, the battery modules are confined by fastening side plates to the lateral sides of the carrier framework. Further, cover plates may be fixed atop and below the battery modules.

The carrier framework of the battery pack is mounted to a carrying structure of the vehicle. In the configuration in which the battery pack shall be fixed at the bottom of the vehicle, the mechanical connection may be established from the bottom side by, for example, bolts passing through the carrier framework of the battery pack. The framework is usually made of aluminum or an aluminum alloy to reduce the total weight of the construction.

Because the battery housing serves as the location for the active and passive components of a battery system, the battery housing plays an important role in the functionality, safety, and service life of the energy storage system. The battery housing is configured to protect the sensitive components from harmful environmental influences such as water, moisture, and dust and is therefore important for the long-term safe and reliable operation. As traction batteries are typically located outside the vehicle cabin, usually in the floor area, the housing is directly exposed to extreme environmental conditions such as temperature, humidity, splash water, salt spray, dust, and stone chipping. High mechanical stability and corrosion resistance are therefore important, even under extreme external conditions. In addition to the environmental influences, which mainly affect the surface of the housing or the tightness of the housing, the internal and external fastening systems are important under vehicle operating conditions.

The above information disclosed in this Background section is only to enhance understanding of background information pertaining to the present disclosure and may contain information that does not constitute prior art.

### SUMMARY

The invention is defined by the appended claims. The description that follows is subjected to this limitation. Any disclosure lying outside the scope of the claims is only intended for illustrative as well as comparative purposes.

A battery pack frame according to one embodiment of the present disclosure includes a top plate configured to frame accommodation chambers for accommodating rechargeable battery cells in which the accommodation chambers are delimited by intersecting lengthwise beams and crosswise beams of the top plate; a bottom plate positioned below the top plate; a cell cooler enclosed by the top plate and the bottom plate for cooling the rechargeable battery cells in which the cell cooler includes sections and voids between the sections; and a foam substantially filling a space between the top plate and the bottom plate and in which the foam extends through the voids of the cell cooler.

Another embodiment of the present disclosure refers to a battery pack including said battery pack frame; rechargeable battery cells accommodated within the battery pack frame; and battery pack frame covers covering the accommodation chambers of the battery pack frame.

Yet another embodiment of the present disclosure pertains to an electric vehicle including such a battery pack.

Further embodiments of the present disclosure could be learned from the dependent claims or the following description.

### BRIEF DESCRIPTION OF THE DRAWINGS

Features will become apparent to those of ordinary skill in the art by describing in detail exemplary embodiments with reference to the attached drawings in which:

FIG. 1A is a perspective view of a battery pack frame according to an embodiment of the present disclosure;

FIG. 1B is a top view of the battery pack frame of FIG. 1A;

FIG. 1C is a cross-section view along line A-A of the battery pack frame illustrated in FIG. 1B;

FIG. 1D illustrates an enlarged section of the battery pack frame of FIG. 1C;

FIG. 1E shows a cross-section view along line B-B of the battery pack frame illustrated in FIG. 1B;

FIG. 1F shows a cross-section view along line C-C of the battery pack frame illustrated in FIG. 1B;

FIG. 2 is a perspective view of the battery pack frame of FIG. 1A accommodating rechargeable battery cells within two accommodation chambers;

FIG. 3A illustrates a perspective view of a battery pack frame according to another embodiment of the present disclosure;

FIG. 3B is a top view of the battery pack frame of FIG. 3A;

FIG. 3C is a cross-section view along line A-A of the battery pack frame illustrated in FIG. 3B;

FIG. 3D is a cross-section view along line B-B of the battery pack frame illustrated in FIG. 3B;

FIG. 4 is a bottom view of a battery pack frame according to another embodiment;

FIG. 5 is a bottom view of a battery pack frame according to another embodiment;

FIG. 6 is a bottom view of a battery pack frame according to another embodiment;

FIG. 7A is a top view of a battery pack frame according to another embodiment of the present disclosure;

FIG. 7B is a cross-section view along line A-A of the battery pack frame illustrated in FIG. 7A;

FIG. 7C is a cross-section view along line C-C of the battery pack frame illustrated in FIG. 7A;

FIG. 8A is a perspective view of a battery pack according to another embodiment of the present disclosure;

FIG. 8B is a side view of the battery pack of FIG. 8A;

FIG. 8C is a cross-section view along line A-A of the battery pack illustrated in FIG. 8B;

FIG. 8D is an enlarged section of the battery pack of FIG. 8C;

FIG. 9A is a top view of a battery pack according to another embodiment of the present disclosure;

FIG. 9B is a cross-section view along line B-B of the battery pack illustrated in FIG. 9A; and

FIG. 10 depicts an electric vehicle including the battery pack of FIG. 8A according to one embodiment of the present disclosure.

### DETAILED DESCRIPTION

Reference will now be made in detail to embodiments, examples of which are illustrated in the accompanying drawings. Effects and features of the exemplary embodiments, and implementation methods thereof will be described with reference to the accompanying drawings. In the drawings, like reference numerals denote like elements, and redundant descriptions are omitted. The present disclosure, however, may be embodied in various different forms, and should not be construed as being limited to only the illustrated embodiments herein. Rather, these embodiments are provided as examples so that this disclosure will be thorough and complete, and will fully convey the embodiments and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

As used herein, the term "and/or" includes any and all combinations of one or more of the associated listed items. Expressions such as “at least one of”, when preceding a list of elements, modify the entire list of elements and do not modify the individual elements of the list. Further, the use of “may” when describing embodiments of the present disclosure refers to “one or more embodiments of the present disclosure." In the following description of embodiments of the present disclosure, the terms of a singular form may include plural forms unless the context clearly indicates otherwise.

It will be understood that although the terms "first" and "second" are used to describe various elements, these elements should not be limited by these terms. These terms are only used to distinguish one element from another element. For example, a first element may be named a second element and, similarly, a second element may be named a first element, without departing from the scope of the present disclosure.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

The term “consisting essentially of” means that specific further components can be present, namely those not materially affecting the essential characteristics of a composition.

It will also be understood that when a film, a region, or an element is referred to as being "above" or "on" another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery pack frame includes a top plate, a bottom plate, a cell cooler, and a foam. The top plate is configured to frame one or more accommodation chambers for accommodating rechargeable battery cells. The accommodation chambers are delimited (bounded) by intersecting lengthwise beams and crosswise beams of the top plate. The bottom plate is positioned below the top plate. Further, the cell cooler is enclosed by the top plate and the bottom plate and is configured for cooling the rechargeable battery cells. The cell cooler includes sections and voids between the sections. Furthermore, the foam fills (or substantially fills) a space between the top plate and the bottom plate, and the foam extends through the voids of the cell cooler.

In one or more embodiments, the outer form (shape) of a battery pack frame for accommodating rechargeable battery cells of a battery pack is determined by a top plate and a bottom plate that are connected to each other. Two different types of beams are formed within the top plate along its longitudinal direction (e.g., the long side direction) and its transverse direction (e.g., the short side direction). The two different types of beams (i.e., the beams along the long side and the beams along the short side of the top plate) intersect each other in such a way that that one or more accommodation chambers for hosting rechargeable battery cells are formed.

The bottom plate is located below the top plate and is configured to provide underride protection of the battery pack against mechanical or environmental influences such as humidity, splash water, dust, and/or stone chipping.

Further, a cell cooler is located between the top plate and the bottom plate. The cell cooler is configured for cooling the rechargeable battery cells during operating conditions (i.e., charging and discharging of the rechargeable battery cells). In one or more embodiments, the cell cooler includes voids (i.e., openings) and the sections of the cell cooler alternate with the voids. The cell cooler may include one cooling unit (e.g., only one cooling unit) such that the voids are located within this unit dividing the cooling unit into several cooling sections. The cooling sections of the cooling unit may be mechanically connected with each other by connecting elements so that the cell cooler may be a one-piece component (e.g., a monolithic component). The connecting elements may also fulfil a cooling function such that the connecting elements include at least some coolant carrying sections. In one or more embodiments, the battery pack frame may include a cell cooler including a plurality of cooling units (e.g. one cooling unit underneath each accommodation chamber). In this embodiment, the voids may be located between the cooling units, irrespective of the presence of any voids within these cooling units.

Further according to the present disclosure, a foam is filled (or substantially filled) in a space between the top plate and the bottom plate such that the cell cooler is embedded in the foam. In one or more embodiments, the foam fills (or substantially fills) areas between the top plate and the cell cooler, and areas between the cell cooler and the bottom plate. The foam-filled areas between the cell cooler and the top plate, and between the cell cooler and the bottom plate, are connected to each other through the voids of the cell cooler. This means that the foam-filled areas in the upper part of the battery pack frame (i.e. inside the beams) and the foam-filled areas in the underbody part of the battery pack frame (i.e. between the cell cooler and the bottom plate) contact each other. Accordingly, in one or more embodiments, the foam-filled areas may be connected together.

A battery pack frame according to the present disclosure is beneficial in various aspects. Firstly, the foam as filling material may increase the mechanical stability of the battery pack frame because the foam provides mechanical load transfer and distribution as well as energy absorption in a battery pack. If, for example, a shock primarily acts locally on an area of the battery pack frame, this mechanical impulse is distributed by the foam over the entire battery pack frame. The voids in the cell cooler through which the foam-filled areas above and below the cell cooler are in contact with each other are important. Assuming, for example, that an impact occurs from the underside of the bottom plate, the impact may be distributed via the foam over the entire foam-filled areas including the areas between the bottom plate and the cell cooler, as well as the foam-filled areas between the cell cooler and the top plate. Secondly, the increased mechanical stability also directly results in increased battery safety, and thus the risk that damage to the rechargeable battery cells could possibly lead to a thermal runaway event may be reduced. Thirdly, the battery pack frame may be a one-piece component (i.e., the battery pack frame may be monolithic). This makes it possible to design the battery pack frame in a particularly space-saving way. Especially for mobile applications, the available space for battery components is limited and thus a one-piece battery pack frame may be beneficial. Furthermore, when installing the battery pack frame as a one-piece component, the assembly time may be shortened and the logistic effort may be reduced.

According to an embodiment, the top plate, the bottom plate, and the cell cooler may be metal plates. This may simplify the processing of these components. In one or more embodiments, molding the beams from the top plate may become easier when using a metal plate compared to other materials. Regarding the cell cooler, the use of metals with a high thermal conductivity, such as aluminum and copper, may be utilized to efficiently distribute locally released heat and thereby reduce the likelihood of the rechargeable battery cells overheating.

According to another embodiment, the top plate and the bottom plate may be held together by at least one of welding, soldering, clinching, screwing, bolting, and/or the foam. In one or more embodiments, the battery pack frame may be held together both by fasteners (e.g., screws) and by the foam. In this way, the foam not only fulfils the purpose of improving mechanical load and distribution within the battery pack frame, but it may also contribute to holding the top plate and the bottom plate together.

According to yet another embodiment, the top plate may include one or more cut-outs in the area of a bottom side of each accommodation chamber such that the upper side of the cell cooler contacts the rechargeable battery cells and the lower side of the cell cooler contacts the foam. The cut-outs may correspond to a portion of the bottom sides or alternatively the cut-outs may correspond to substantially the entire area of the bottom sides (e.g., the cut-outs extend over the majority of the area of the bottom sides of the accommodate chambers). In one or more embodiments in which the cut-out correspond to substantially the entire area of the bottom side of the accommodation chambers, the bottom side of each accommodation chamber is built (formed) by the cell cooler. This means that the underside of the rechargeable battery cells contacts (e.g., directly contacts) the top of the cell cooler after assembly in the accommodation chambers while the foam is underneath the cell cooler. The contact between the rechargeable battery cells and the cell cooler may contribute significantly to efficient heat distribution, while filling (or substantially filling) the space between the cell cooler and the bottom plate with the foam may improve stability of the battery pack since the weight of the rechargeable battery cells may be efficiently distributed over the foam-filled space.

According to a further embodiment, one or more reinforcement elements may be installed in tie-in points of the lengthwise beams and the crosswise beams. The reinforcement elements may be configured as bracings such that in the area of the intersecting beams, the reinforcement elements may be attached to the beams and abut the bottom of the accommodation chambers. In one or more embodiments, the reinforcement elements may be attached to the bottom side of the accommodation chambers and abut the lengthwise beams and the crosswise beams. In one or more embodiments, the reinforcement elements may be made from tubing or roll formed sheet metal. The reinforcement elements may enable the mechanical load on the battery pack frame (e.g., during operation or in the event of an accident) to be efficiently distributed over the battery pack frame, thereby reducing the likelihood of damage of one or more of the lengthwise beams or the crosswise beams.

According to yet another embodiment, the battery pack frame may further include hollow tubes being embedded within the foam and extending along the outer lengthwise beams of the battery pack frame. The hollow tubes may contribute to additional load distribution from the tie-in points as well as from the reinforcement elements for side-impacts. The hollow tubes may have a shape selected from the group consisting of rectangular, square, round, and elliptical.

According to another embodiment, the bottom plate may include pressed features selected from the group including pot-like dimple elements, trapezoid shaped ribbing, and corrugated wave shapes. The configuration of the bottom plate may contribute to an efficient distribution and conversion of impact forces from below the battery pack frame. In this manner, the risk of serious damage to one of the battery packs (e.g., in the event of an accident) may be reduced.

According to yet another embodiment, the cell cooler may be a roll-bonding cooler. A roll-bonding cooler may be beneficial since, on the one hand, the roll-bonding cooler may be easily inserted into the structure of the battery pack frame (i.e. between the top plate and the bottom plate). On the other hand, the roll-bonding cooler may efficiently dissipate the heat from the rechargeable battery cells under normal operating conditions (i.e., charging and discharging) such that the rechargeable battery cells may not overheat.

According to a further embodiment, the voids of the cell cooler may be located underneath the lengthwise beams and the crosswise beams, which enables the foam to be filled in during assembly of the battery pack. Furthermore, the areas filled (or substantially filled) with foam in the lengthwise and crosswise beams, and the areas filled (or substantially filled) with foam between the cell cooler and the bottom plate contact each other through the voids of the cell cooler, thereby enabling a monolithic foam body below and above the cell cooler.

According to another embodiment, the foam may be formed of (or include) polyurethane. In one or more embodiments, the foam may consist essentially of polyurethane. Polyurethanes may be particularly suitable since these compounds are relatively inexpensive to produce and their mechanical properties, such as density and moldability, can be varied within a wide range by the degree of cross-linking and the type of monomers used.

According to yet another embodiment, the foam may be composed of two or more materials differing in at least one of density and/or stiffness, and the space between the top plate and the bottom plate may be divided into spatially separated areas that are equal in number to the number of different materials of the foam. Additionally, in one or more embodiments, each different foam material may fill (or substantially fill) one of the spatially separated areas of the space between the top plate and the bottom plate. In other words, the foam may include two or more different materials and each of these foam materials fills (or substantially fills) different spatially delimited areas in the battery pack frame. In this way, the mechanical characteristics of the battery pack frame may be further improved. In one or more embodiments, such a combination of different foams may be achieved by firstly pre-molding a first foam material into the desired shape. These pre-shaped foam structures may then be inserted into the battery pack frame before the top plate and the bottom plate are coupled together. The bonding of the first foam material may either be done by adhering (e.g., gluing) them to the other components during the assembly of the outer hull, or the first foam material may be bonded in place and to the other components by a second foam material being injected to the battery pack frame after the outer assembly is put together.

According to a further embodiment, a battery pack includes one battery pack frame as described above; a plurality of rechargeable battery cells accommodated within the battery pack frame; and a plurality of battery pack frame covers covering the accommodation chambers of the battery pack frame. Within each accommodation chamber, a number of rechargeable battery cells are assembled in a stack. Prismatic battery cells may be utilized because, for example, the long sides of the prismatic battery cells may be arranged adjacent to each other. For example, each accommodation chamber formed by the top plate may accommodate one of these battery cell stacks. The battery cell stacks, and the rechargeable battery cells thereof, may be configured in a series, parallel, or a mixture of series and parallel to deliver the desired voltage, capacity, and power density. The battery cell stacks may be connected by electrical elements providing electrical conductivity between the battery cell stacks. Moreover, the battery pack may include further components such as, for example, a battery management system (BMS), which is any suitable electronic system that is configured to manage the battery pack, such as by protecting the rechargeable battery cells from operating outside their safe operating area, monitoring their states, calculating secondary data, reporting that data, controlling its environment, authenticating it, and balancing it.

According to another embodiment, each of the battery pack frame covers may be configured to maintain pressure on the rechargeable battery cells. This may be achieved, for example, by configuring the battery pack frame covers such that they are pre-tensioned before installation of the rechargeable battery cells. Accordingly, after assembly of the rechargeable battery cells, the battery pack frame covers exert pressure on the rechargeable battery cells from the top over the entire battery cell stacks. This is configured to ensure that the underside of the rechargeable battery cells contacts the cell cooler such that efficient heat dissipation may be achieved. Further, this configuration of the battery pack frame covers may contribute to a mechanical stability of the battery pack by sufficiently firmly attaching the rechargeable battery cells.

According to yet another embodiment, the battery pack frame covers may include corrugations configured to form vent-gas channels over the rechargeable battery cells. These corrugations may be the actual portions of the battery pack frame cover that are exerting pressure on the rechargeable battery cells. Further, a battery cell vent cover may be clamped between the top side of the rechargeable battery cells and the battery pack frame covers, and the battery cell vent cover may be formed of (or include) an elastic material. In one or more embodiments, the battery cell vent cover may consist essentially of elastic material. In this way, the pre-tension of the battery pack frame covers may ensure mechanical stability of the battery pack. For instance, height differences between the rechargeable battery cells may effectively be compensated for and the pressure exerted on the rechargeable battery cells may be minimized (or at least reduced). Further, the battery pack frame covers may also contribute to the safety of the battery pack by forming the vent-gas channels, which facilitates the efficient dissipation of hot venting products released from at least one of the rechargeable battery cells and thereby avoids (or at least mitigates) possible consequential damage to the battery pack.

A further embodiment pertains to an electric vehicle including the above-mentioned battery pack.

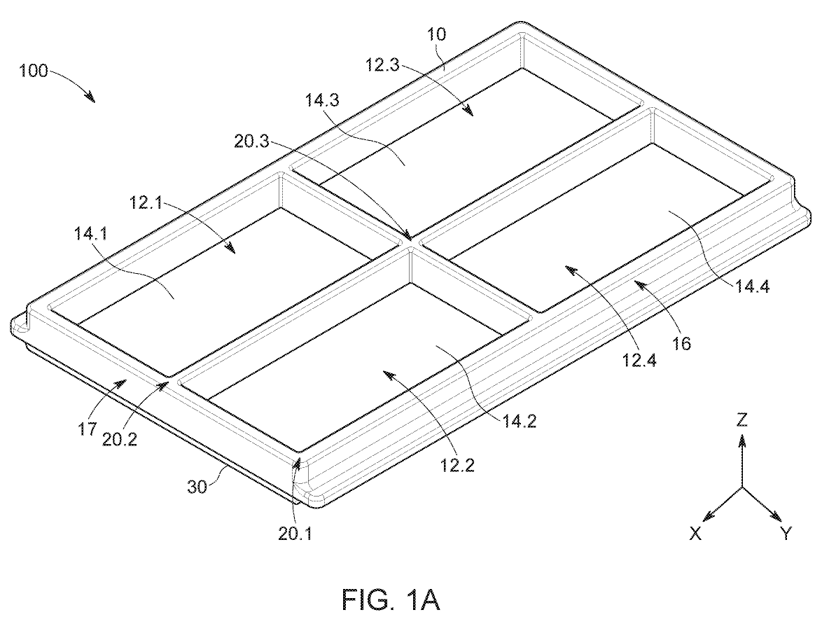

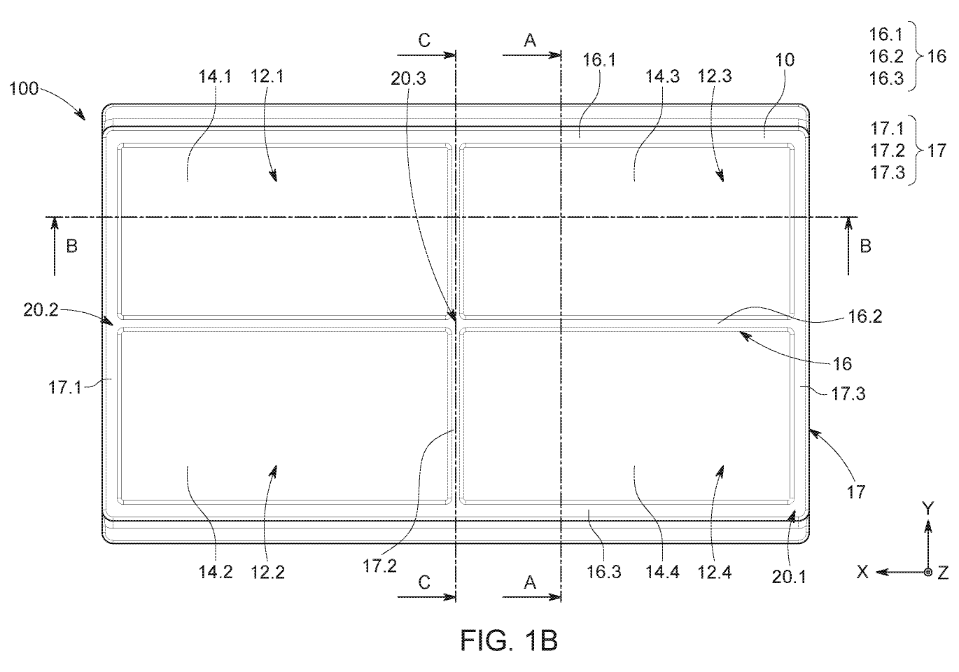

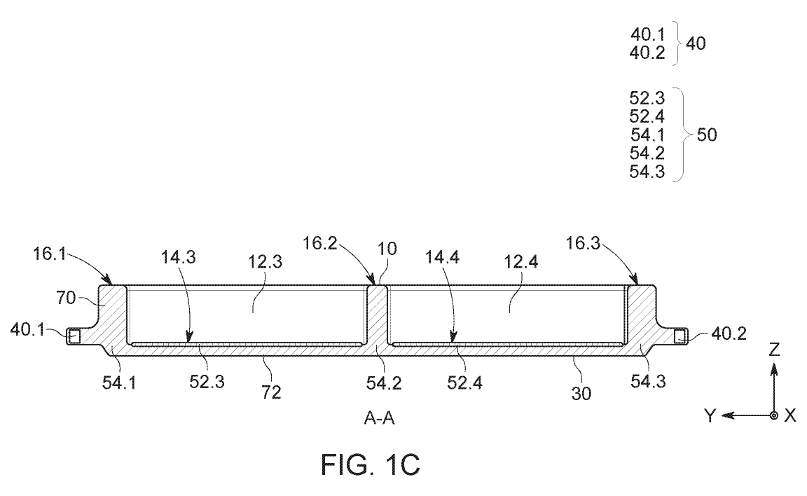

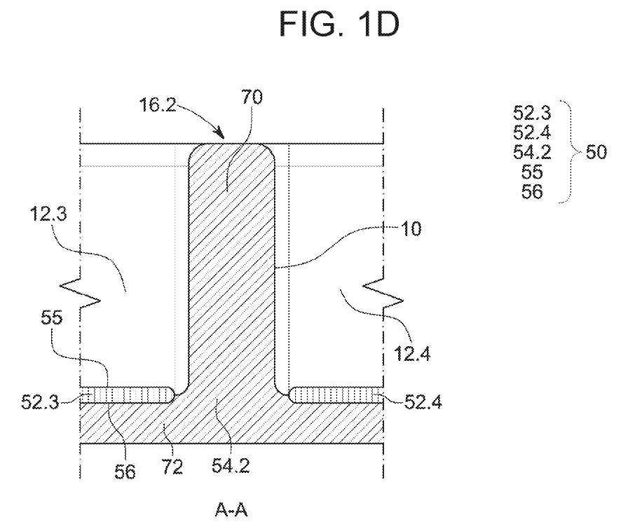

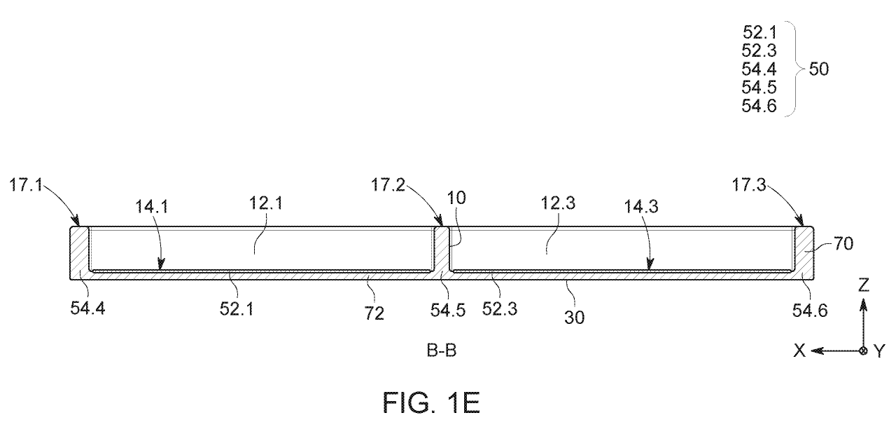

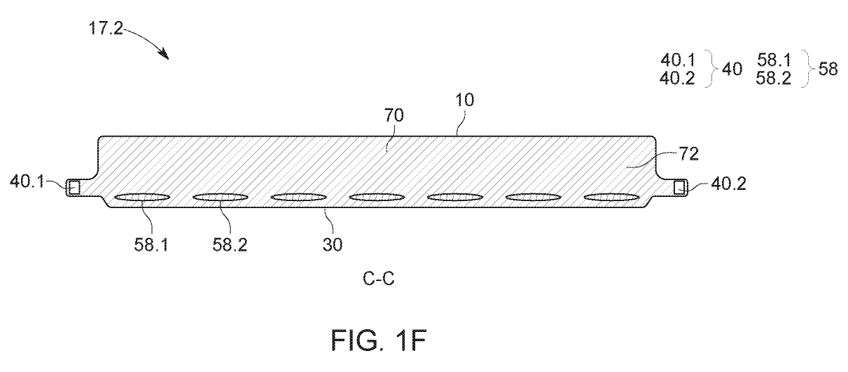

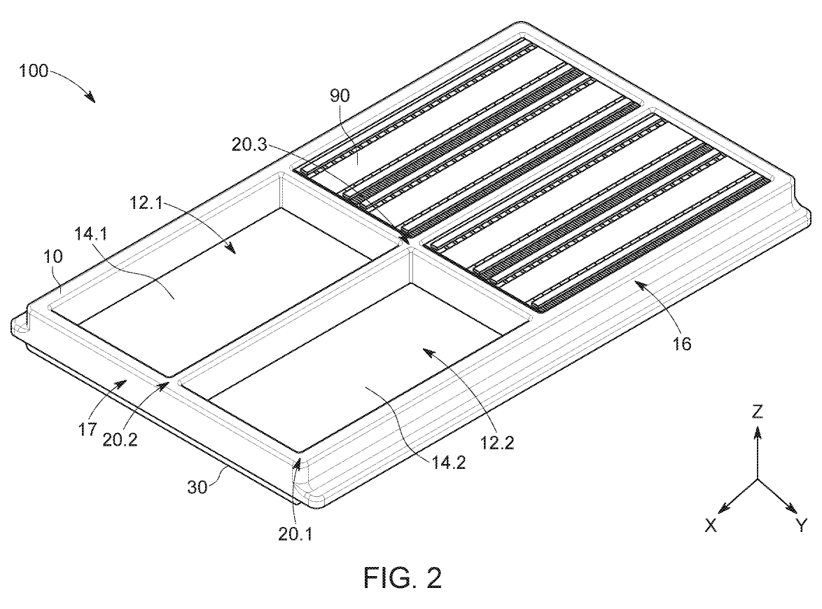

FIG. 1A is a perspective view of battery pack frame 100 according to an embodiment of the present disclosure. The battery pack frame 100 includes a top plate 10, a bottom plate 30, a cell cooler 50 (not shown in FIG. 1A, see FIG. 1C) and a foam 70 (not shown in FIG. 1A, see FIG. 1C). In FIG. 1A, the X-axis may refer to a longitudinal direction of top plate 10, the Y-axis may refer to a transverse direction of top plate 10, and the Z-axis may refer to a height direction of the battery pack frame 100. These axis definitions may also apply to the following figures. The outer shape of the battery pack frame 100 is determined by the top plate 10 and the bottom plate 30 positioned below the top plate 10. Beams 16,17 extend from (e.g., are molded through) the top plate 10. In one or more embodiments, there are two different types of beams: one type of beams extends along the longitudinal side of the top plate 10 (i.e., lengthwise beams 16), and the other type of beams extends along the transverse side of the top plate 10 (i.e., crosswise beams 17). The lengthwise and crosswise beams 16,17 intersect at tie-in points 20.1-20.3. Four accommodation chambers 12.1-12.4 for accommodating rechargeable battery cells 90 (shown in FIG. 2) are formed by the intersecting lengthwise and crosswise beams 16,17. In this way, each of the accommodation chambers 12.1-12.4 is delimited laterally by two lengthwise and crosswise beams 16,17. A boundary extending downwards within the accommodation chambers 12 is realized by bottom sides 14.1-14.4.

FIG. 1B is a top view of the battery pack frame 100 of FIG. 1A. The FIG. 1B illustrates the battery pack frame 100 having the four accommodation chambers 12.1-12.4 which are divided by the lengthwise and crosswise beams 16,17.

FIG. 1C shows a cross-section along line A-A of the battery pack frame 100 illustrated in FIG. 1B. As shown in FIG. 1B, the line A-A extends in the transverse direction through the accommodation chambers 12.3,12.4. Accordingly, the accommodation chambers 12.3,12.4 are delimited laterally by the lengthwise beams 16.1-16.3 formed by the top plate 10. The battery pack frame 100 is bounded vertically (i.e., on top and bottom) by the top plate 10 and the bottom plate 30. The longitudinal beams 16.1-16.3 are formed within the top plate 10. The cell cooler 50 is positioned between the top plate 10 and the bottom plate 30. The cell cooler 50 includes voids 54.1-54.3 between sections 52.3,52.4 of the cell cooler 50. The voids 54.1-54,3 are located underneath the lengthwise beams 16.1-16.3. Further, the top plate 10 includes cut-outs in the area of the bottom sides 14.3,14.4 of the accommodation chambers 12.3,12.4 such that the cell cooler 50 is not covered (or substantially not covered) by the top plate 10 in the area of the bottom sides 14.3,14.4. As a result, the rechargeable battery cells 90 (see FIG. 2) and the cell cooler 50 contact each other after assembly, thereby enabling more effective cooling than if there were an additional component (e.g., the top plate 10) between the rechargeable battery cells 90 and the cell cooler 50. Additionally, in one or more embodiments, the battery pack frame 100 includes a foam 70 filling (or substantially filling) a space 72 between the top plate 10 and the bottom plate 30 and embeds the cell cooler 50. The foam 70 fills (or substantially fills) the space 72 within the lengthwise beams 16 and between the cell cooler 50 and the bottom plate 30, and the voids 54 of the cell cooler 50, which are located underneath the lengthwise beams 16, enable connectivity of the foam 70 throughout the entire battery pack frame 100. In this manner, the foam 70 is easily filled in during assembly and a direct coupling of the foam 70 in the lengthwise beams 16 with the foam 70 filled between the cell cooler 50 and the bottom plate 30 is achieved. Due to this direct coupling of the foam-filled areas, improved mechanical load transfer and distribution as well as energy absorption within the battery pack frame 100 is provided compared to battery pack frame without such coupling between the foam-filled areas. Further, two rectangular hollow tubes 40.1,40.2 are embedded within the foam 70 and extend along the outer lengthwise beams 16.1,16.3. The hollow tubes 40.1,40.2 contribute to additional load distribution from the tie-in points 20 for side-impacts.

An enlarged section of the battery pack frame 100 of FIG. 1C is illustrated in FIG. 1D. FIG. 1D shows a section around the lengthwise beam 16.2 separating the accommodation chambers 12.3,12.4 from each other. As shown, the foam 70 fills (or substantially fills) the space 72 between the top plate 10 and the bottom plate 30. Further, the cell cooler 50 includes the two sections 52.3,52.4 separated by the void 54.2 underneath the lengthwise beam 16.2. The cell cooler 50 is mounted such that the upper side of the cell cooler 50 contacts the rechargeable battery cells 90 while the lower side of the cell cooler 56 contacts the foam 70. The contact between the cell cooler 50 and the rechargeable battery cells 90 ensures efficient cooling of the rechargeable battery cells 90 under operating conditions. The lining with the foam 70 contributes to mechanical stability of the battery pack frame 100 because forces acting on the cell cooler 50 may be better distributed through the entire battery pack frame 100.

FIG. 1E is a cross-section along line B-B of the battery pack frame 100 illustrated in FIG. 1B. As shown in FIG. 1B, the line B-B extends in longitudinal direction through the accommodation chambers 12.1,12.3. Accordingly, the accommodation chambers 12.1,12.3 are delimited (bounded) laterally by the crosswise beams 17.1-17.3 formed by the top plate 10. The cell cooler 50 including the sections 52.1,52.3 and the voids 54.4-54.6 is enclosed by the top plate 10 and the bottom plate 30, and the space 72 between the top plate 10, bottom plate 30, cell cooler 50 is filled (or substantially filled) by the foam 70. The voids 54.4-54.6 within the cell cooler 50 are located underneath the crosswise beams 17.1-17.3, thereby enabling easy filling of the foam 70 during assembly as well as ensuring contact between the foam 70 filled (or substantially filled) inside the crosswise beams 17.1-17.3 with the foam 70 filled (or substantially filled) between the cell cooler 50 and the bottom plate 30.

FIG. 1F is a cross-section along line C-C of the battery pack frame 100 illustrated in FIG. 1B. As shown in FIG. 1B, the line C-C extends in the transverse direction through a crosswise beam 17 of the battery pack frame 100. Accordingly, FIG. 1F depicts a cross-section of the crosswise beam 17.2. As it can be seen, the outer shape of the crosswise beam 17.2 is determined by the top plate 10 and the bottom plate 30. The space 72 between the top plate 10 and the bottom plate 30 is filled (or substantially filled) with the foam 70 embedding the two rectangular hollow tubes 40.1,40.2 and connecting elements 58 of the cell cooler 50. The connecting elements 58 (e.g., 58.1 and 58,2) of the cell cooler 50 mechanically connect the cooler sections 52 of the cell cooler 50.

FIG. 2 is a perspective view on the battery pack frame 100 of FIG. 1A accommodating a plurality of rechargeable battery cells 90 in the accommodation chambers 12.3,12.4 according to one embodiment of the present disclosure.

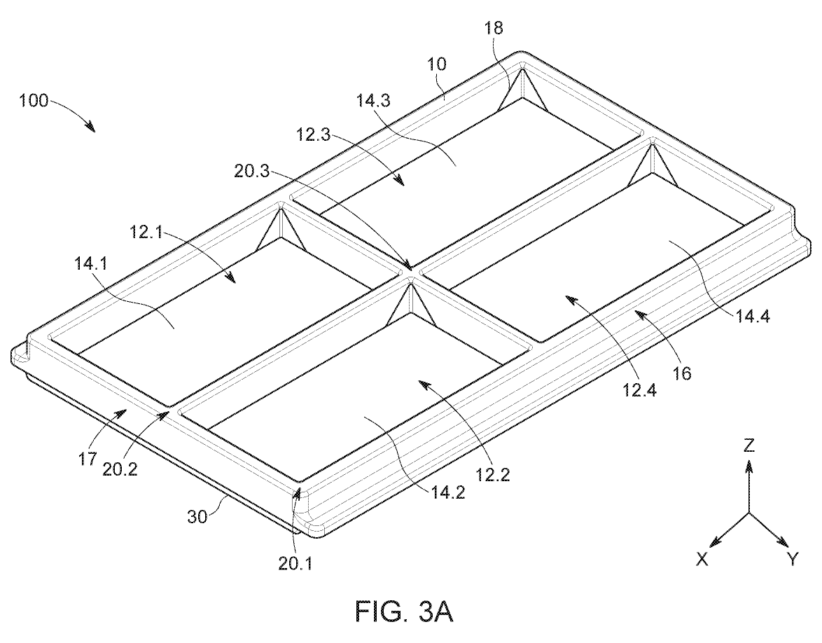

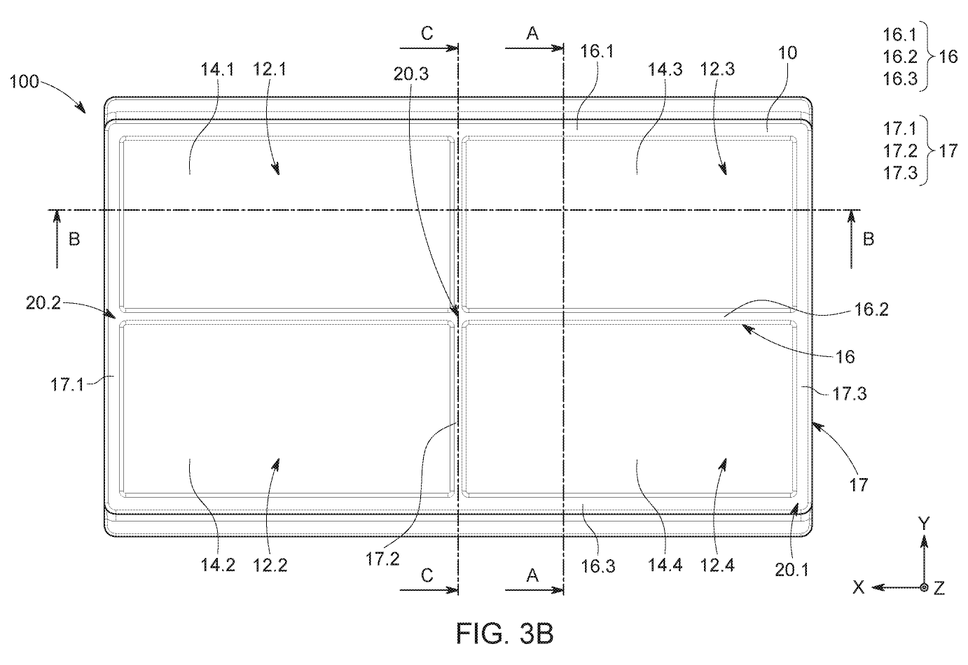

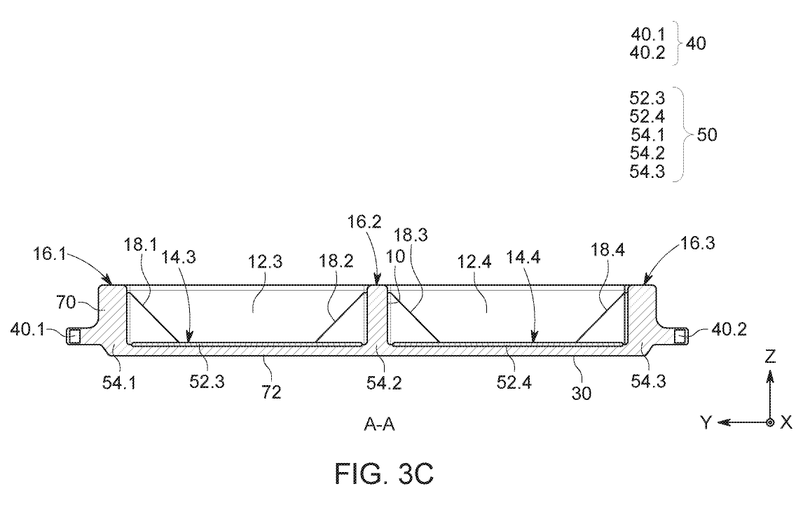

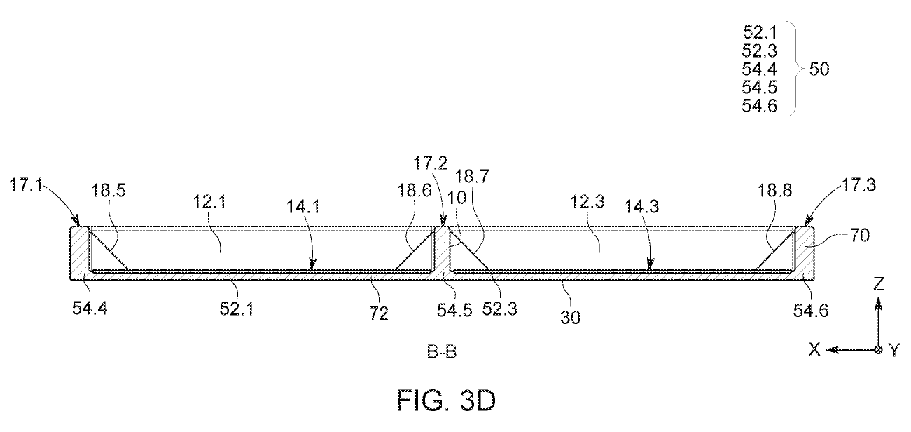

FIG. 3A illustrates a perspective view of a battery pack frame 100 according to another embodiment of the present disclosure. The battery pack frame 100 differs from the battery pack frame 100 shown in FIG. 1A due to the inclusion of reinforcement elements 18. For reasons of redundancy, only the reinforcement elements 18 and their effects on the battery pack frame 100 will be discussed in more detail below. The reinforcement elements 18 (e.g., 18.1-18.4 shown in FIG. 3C 18.5-18.8 shown in FIG. 3D) are installed in tie-in points 20.1-20.3 of the lengthwise and crosswise beams 16,17. The reinforcement elements 18 are configured such that they start from the beams 16,17 and rest on the upper side of the bottom side 14 of the accommodation chambers 12. In one or more embodiments, the reinforcement elements 18 are in the corners of the accommodation chambers 12.3,12.4. In one or more embodiments, the reinforcement elements 18 are made from tubing or roll formed sheet metal. In this manner, the mechanical load on the battery pack frame 100 (e.g., during charging and discharging or in the event of an accident) may be efficiently distributed over the battery pack frame 100, thereby reducing the likelihood of damage of one or more beams 16,17.

FIG. 3B is a top view of the battery pack frame 100 of FIG. 3A. Due to the perspective shown in FIG. 3B, the reinforcement elements 18 are not visible in FIG. 3B.

FIG. 3C shows a cross-section along line A-A of the battery pack frame 100 illustrated in FIG. 3B. As shown in FIG. 3B, the line A-A extends in the transverse direction through the accommodation chambers 12.3,12.4. Accordingly, the accommodation chambers 12.3,12.4 are delimited (bounded) laterally by the lengthwise beams 16.1-16.3 formed by the top plate 10. In contrast to the battery pack frame 100 as illustrated in FIG. 1C, the reinforcement elements 18.1-18.4 are present. The reinforcement elements 18.1-18.4 are attached to the lengthwise beams 16.1-16.3 and abut the bottom sides 14.3,14.4 of the accommodation chambers 12.3,12.4. Further, two rectangular hollow tubes 40.1,40.2 are embedded within the foam 70 and extend along the outer lengthwise beams 16.1,16.3. The hollow tubes 40.1,40.2 contribute to additional load distribution from the tie-in points 20 as well as from the reinforcement elements 18 for side-impacts.

FIG. 3D is a cross-section along line B-B of the battery pack frame 100 illustrated in FIG. 3B. As shown in FIG. 3B, the line B-B extends in the longitudinal direction through the accommodation chambers 12.1,12.3. Accordingly, the accommodation chambers 12.1,12.3 are delimited (bounded) laterally by the crosswise beams 17.1-17.3 formed by the top plate 10. In contrast to the battery pack frame 100 as illustrated in FIG. 1E, the reinforcement elements 18.5-18.8 are present. The reinforcement elements 18.5-18.8 are attached to the crosswise beams 17.1-17.3 and abut the bottom sides 14.1,14.3 of the accommodation chambers 12.1,12.3.

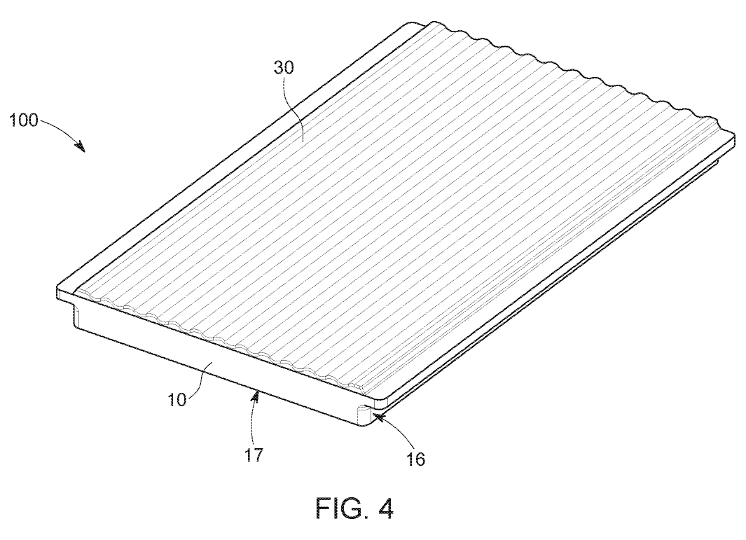

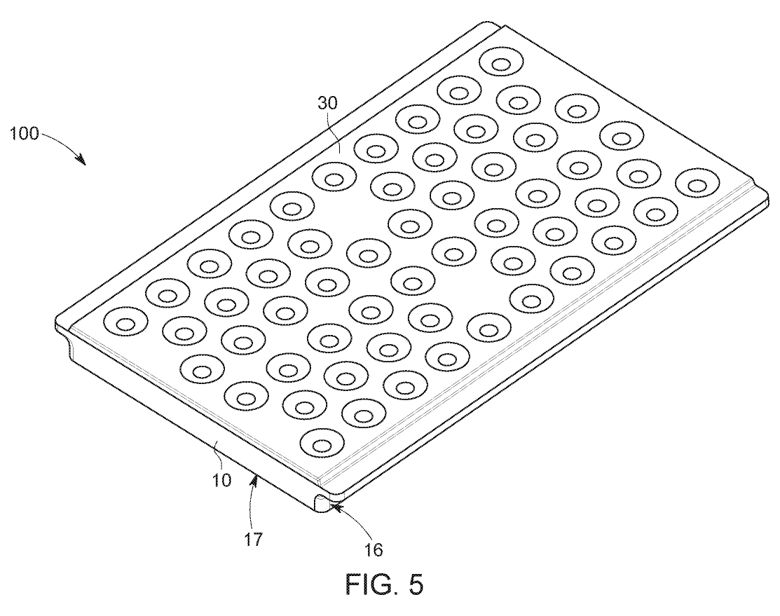

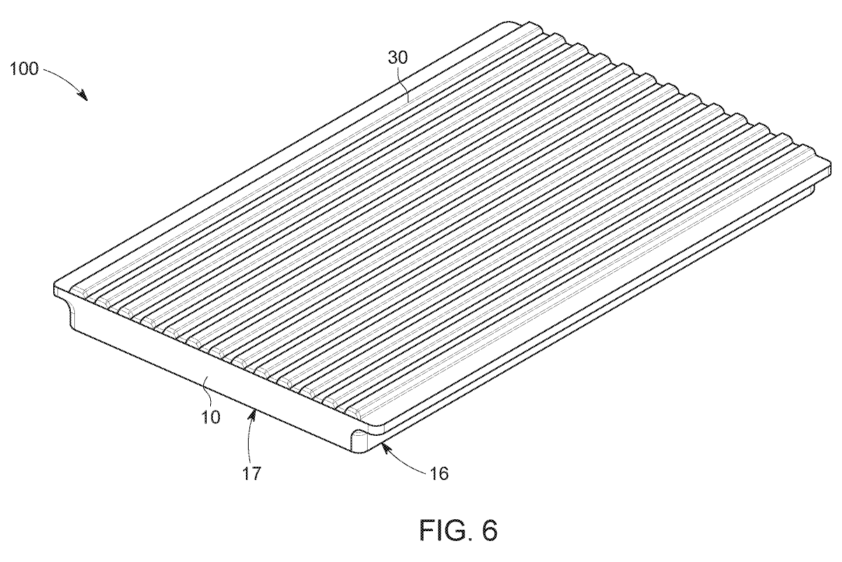

Each of FIGS. 4, 5 and 6 shows a bottom view of a battery pack frame 100 according to other embodiments of the present disclosure. The bottom plate 30 includes additional pressed features for the distribution and conversion of impact forces. Regarding the embodiments, the bottom plate 30 in FIG. 4 incorporates corrugated wave shapes elements; the bottom plate 30 in FIG. 5 incorporates pot-like dimple elements; and the bottom plate 30 in FIG. 6 incorporates trapezoid shaped ribbing.

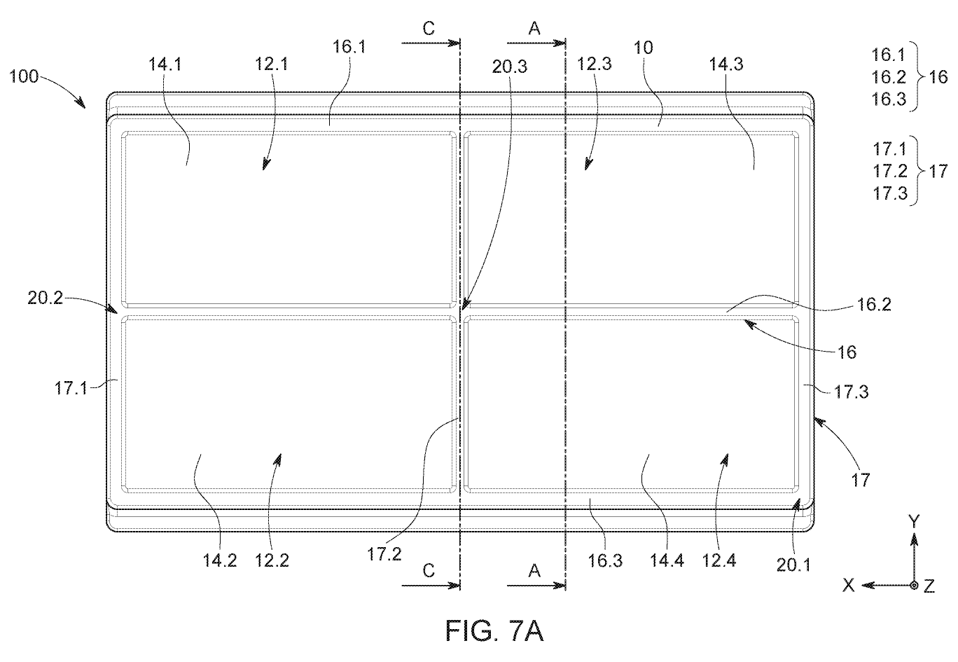

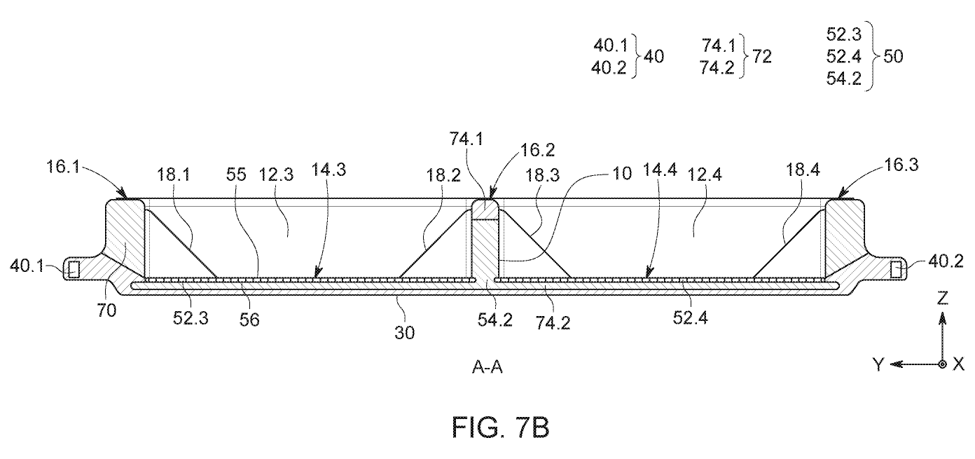

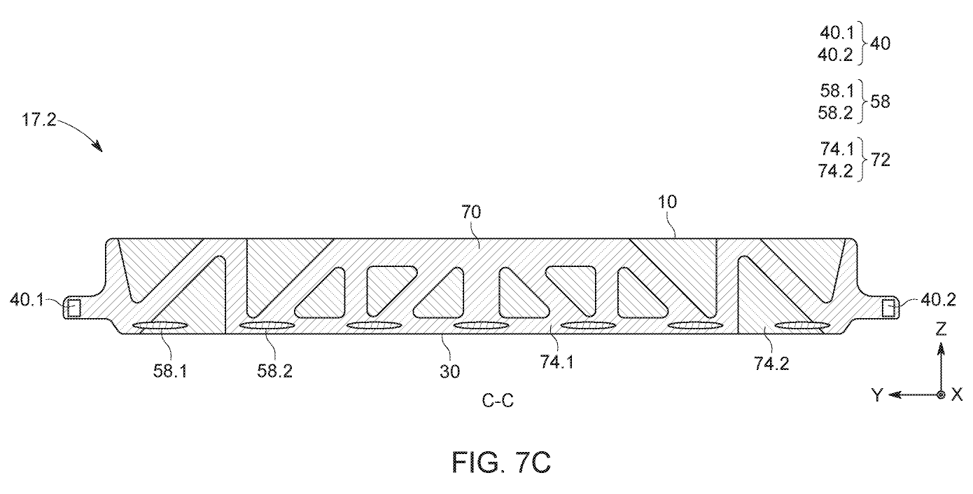

FIG. 7A illustrates a top view on a battery pack frame 100 according to another embodiment of the present disclosure.

FIG. 7B shows a cross-section along line A-A of the battery pack frame 100 illustrated in FIG. 7A. As shown in FIG. 7A, the line A-A extends in the transverse direction through the accommodation chambers 12.3,12.4. Accordingly, the accommodation chambers 12.3,12.4 are delimited (bounded) laterally by the lengthwise beams 16.1-16.3 formed by the top plate 10. The embodiment illustrated in FIG. 3C includes the reinforcement elements 18.1-18.4. The reinforcement elements 18.1-18.4 are attached to the lengthwise beams 16.1-16.3 and abut the bottom side 14.3,14.4 of the accommodation chambers 12.3,12.4. In contrast to the embodiment illustrated in FIG. 3C, two different types of foam materials are filled (or substantially filled) into two different separated areas 74.1,74.2, respectively, within the space 72 between the top plate 10 and the bottom plate 30. In one or more embodiments, the two different foam materials may differ in their densities (i.e., one foam material may have a higher density than the other foam material). In one or more embodiments, the area 74.1 is filled (or substantially filled) by a first foam material and the area 74.2 is filled (or substantially filled) by a second foam material having a smaller density compared to the first foam material. Such a combination of different foam materials can be achieved by firstly pre-molding a first foam material into the desired shape. These pre-shaped foam structures may then be inserted to the battery pack frame 100 before the top plate 10 and the bottom plate 30 are closed together. The first foam material may be bonded in place by the second foam material being injected to the battery pack frame after the outer assembly is put together. By using different types of foam materials, the mechanical characteristics of the battery pack frame 100 as outlined above may further be improved. Further, two rectangular hollow tubes 40.1,40.2 are embedded within the foam 70 and extend along the outer lengthwise beams 16.1,16.3. The hollow tubes 40.1,40.2 contribute to additional load distribution from the tie-in points 20 as well as from the reinforcement elements 18 for side-impacts.

FIG. 7C is a cross-section along line C-C of the battery pack frame 100 illustrated in FIG. 7A. As shown in FIG. 7A, the line C-C extends in the transverse direction through a crosswise beam 17 of the battery pack frame 100. Accordingly, a cross-section of the crosswise beam 17.2 is depicted in FIG. 7C. The space 72 between the top plate 10 and the bottom plate 30 is filled (or substantially filled) with the foam 70 embedding the two rectangular hollow tubes 40.1,40.2 and connecting elements 58 of the cell cooler 50. The connecting elements 58 of the cell cooler 50 mechanically connect the cooler sections 52 of the cell cooler 50. In one or more embodiments, the space 72 between the top plate 10 and the bottom plate 30 includes two different areas 74.1,74.2 filled (or substantially filled) with a foam material having different densities (e.g., a foam material having a relatively higher density in area 74.1, and a foam material having a relatively lower density in area 74.2).

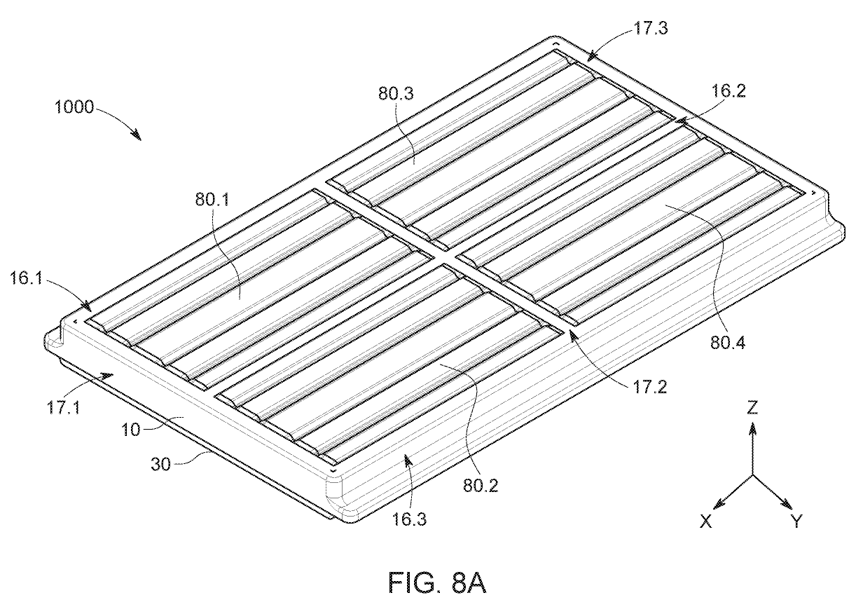

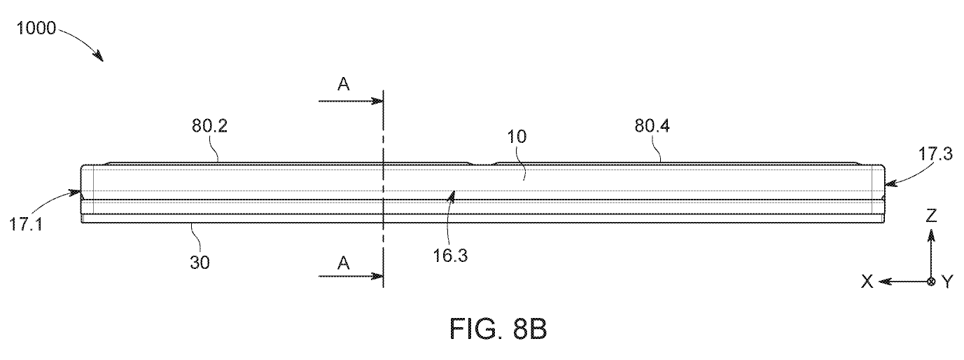

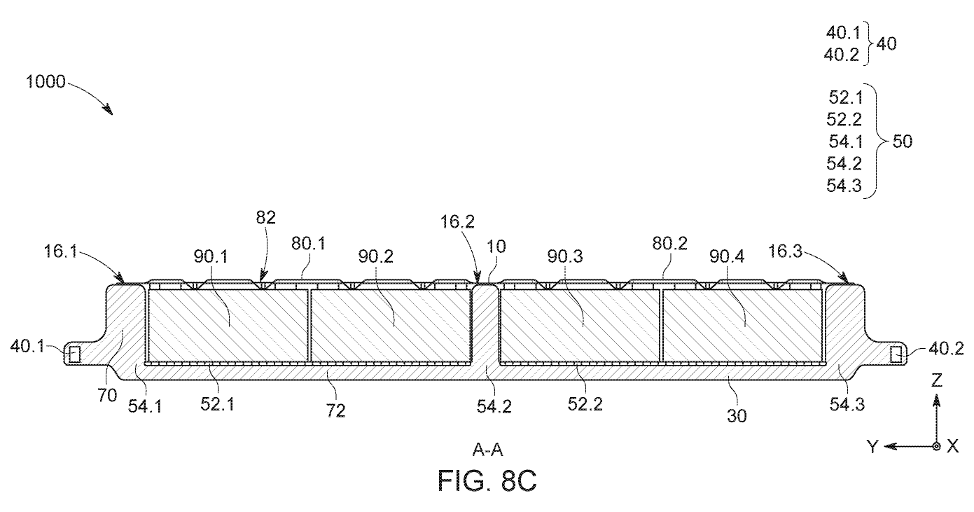

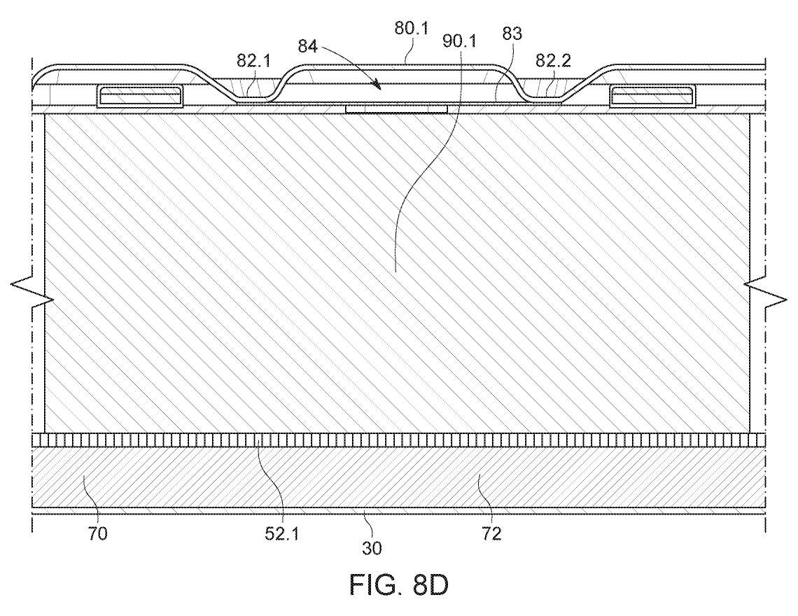

FIG. 8A is a perspective view of a battery pack 1000 according to another embodiment of the present disclosure. The battery pack 1000 includes one battery pack frame 100, for example a battery pack frame 100 as illustrated in FIG. 3A; a plurality of rechargeable battery cells 90 (not shown) accommodated within the battery pack frame 100; and battery pack frame covers 80.1-80.4 covering the accommodation chambers 12.1-12.4 (not shown) of the battery pack frame 100. In FIG. 8A, the view of the rechargeable battery cells 90 and the accommodation chambers 12.1-12.4 is obstructed by the battery pack frame covers 80.1-80.4. The battery pack 1000 also includes further features, such as electrical means for connecting the rechargeable battery cells 90 (e.g. a busbar), and components for monitoring the state of the rechargeable battery cells (e.g., a battery management system (BMS)).

FIG. 8B illustrates a side view of the battery pack 1000 shown in FIG. 8A.

FIG. 8C shows a cross-section along line A-A of the battery pack 1000 illustrated in FIG. 8B. The rechargeable battery cells 90.1-90.4 are covered by the battery pack frame covers 80.1,80.2. The battery pack frame covers 80.1,80.2 include corrugations 82 exerting pressure on the upper side of the rechargeable battery cells 90.1-90.4. Further, two rectangular hollow tubes 40.1,40.2 are embedded within the foam 70 and extend along the outer lengthwise beams 16.1,16.3. The hollow tubes 40.1,40.2 contribute to additional load distribution for side-impacts.

An enlarged section of the battery pack 1000 of FIG. 8C is illustrated in FIG. 8D. FIG. 8D shows a section around the rechargeable battery cell 90.1. The bottom of the rechargeable battery cell 90.1 contacts the section 52.1 of the cell cooler 50 while the top of the rechargeable battery cell 90.1 is pressed down by the corrugations 82.1,82.2 of the battery pack frame cover 80.1. The corrugations 82.1,82.2 of the battery pack frame cover 80.1 form a vent-gas channel 84 above the rechargeable battery cell 90.1. In this way, an efficient dissipation of hot venting gasses from the rechargeable battery cell 90.1 is ensured and thereby avoiding possible consequential damage of the battery pack. Additionally, in one or more embodiments, the rechargeable battery cell 90.1 is protected from hot venting gasses released by one or more other rechargeable battery cells 90 by a battery cell vent cover 83 clamped in between the top side of the rechargeable battery cell 90.1 and the corrugations 82.1 and 82.2 of the battery pack frame cover 80.1. The battery cell vent cover 83 is formed of (or includes) an elastic material configured to ensure that height differences between the rechargeable battery cells 90 and further rechargeable battery cells 90 is compensated for, and that a minimum pressure is exerted on the rechargeable battery cell 90.1.

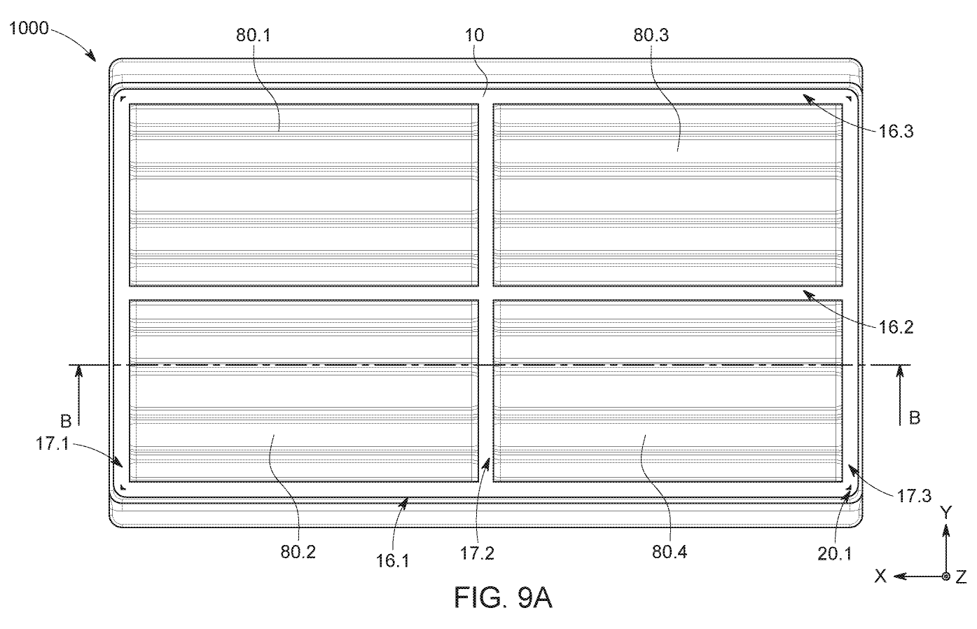

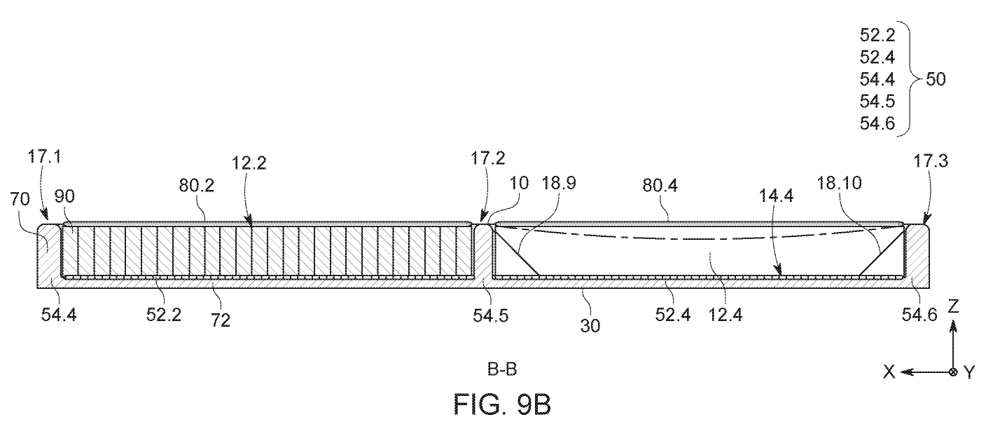

FIG. 9A illustrates a top view of a battery pack 1000 according to a further embodiment of the present disclosure.

FIG. 9B shows a cross-section along line B-B of the battery pack 1000 illustrated in FIG. 9A. As shown in FIG. 9A, the line B-B extends in the longitudinal direction through the accommodation chambers 12.2,12.4. Accordingly, the accommodation chambers 12.2,12.4 are delimited (bounded) laterally by the crosswise beams 17.1-17.3 formed by the top plate 10. The battery pack frame covers 80.2,80.4 are configured to maintain pressure on the rechargeable battery cells 90 from the top over the entire length of the stack of rechargeable battery cells 90. For illustrating this feature, a plurality of rechargeable battery cells 90 is assembled in the accommodation chamber 12.2, while there are no rechargeable battery cells 90 accommodated within the accommodation chamber 12.4. The dash-dotted line in the accommodation chamber 12.4 indicates an untensioned shape of the battery pack frame cover 80.4. When installing rechargeable battery cells 90, such as in the accommodation chamber 12.2, the battery pack frame cover 80.4 tensions and exerts a pressure on the upper side of the rechargeable battery cells 90. This design is advantageous in various aspects. Firstly, the rechargeable battery cells 90 are fixed inside the battery pack 1000 by the battery pack frame cover 80.4, thereby preventing the rechargeable battery cells 90 from falling over or shifting. Thus, the mechanical stability of the battery pack 1000 is improved as well as it is ensured that the electrical contacts within the battery pack 1000 remain intact. Secondly, as the rechargeable battery cells 90 are pressed against the section 52.2 of the cell cooler 50, direct contact between the rechargeable battery cells 90 and the cell cooler 50 is created, which is configured to ensure effective cooling of the rechargeable battery cells 90.

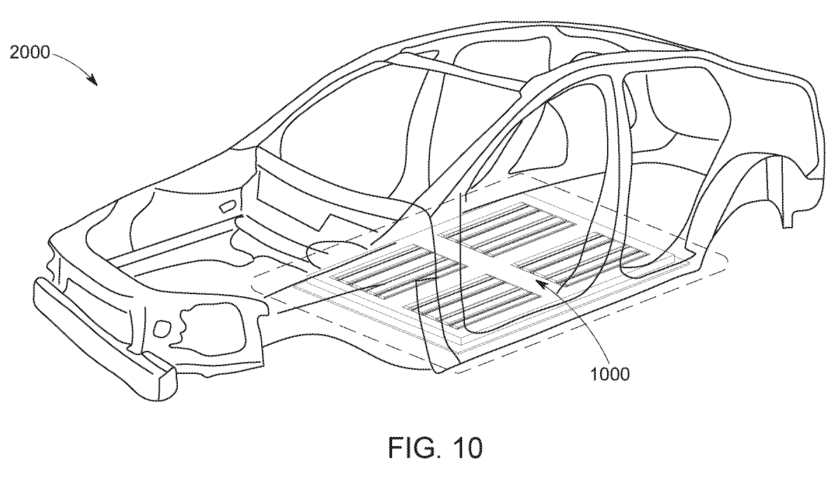

FIG. 10 is a schematic representation of an electric vehicle 2000 according to one embodiment of the present disclosure including the embodiment of the battery pack 1000 as illustrated in FIG. 8A.

### REFERENCE SIGNS

10 top plate

12.1-12.4 accommodation chamber

14.1-14.4 bottom side of accommodation chamber

16, 16.1-16.3 lengthwise beam

17, 17.1-17.3 crosswise beam

18, 18.1-18.10 reinforcement element

20, 20.1-20.3 tie-in point of lengthwise and crosswise beam

30 bottom plate

40, 40.1, 40.2 hollow tube

50 cell cooler

52.1-52.4 section of cell cooler

54.1-54.6 void of cell cooler

55 upper side of cell cooler

56 lower side of cell cooler

58, 58.1, 58.2 connecting element of the cell cooler

70 foam

72 space between top plate and bottom plate

74.1,74.2 separated area in space between top plate and bottom plate

80.1-80.4 battery pack frame cover

82, 82.1-82.2 corrugation of battery pack frame cover

83 battery cell vent cover

84 vent-gas channel

90, 90.1-90.4 rechargeable battery cell

100 battery pack frame

1000 battery pack

2000 electric vehicle

What is claimed is:

1. A battery pack frame, comprising:
a top plate configured to frame accommodation chambers for accommodating rechargeable battery cells, wherein the accommodation chambers are delimited by intersecting lengthwise beams and crosswise beams formed by the top plate;
a bottom plate positioned below the top plate;
a cell cooler enclosed by the top plate and the bottom plate for cooling the rechargeable battery cells, wherein the cell cooler comprises sections and voids between the sections; and
a foam substantially filling a space between the top plate and the bottom plate, wherein the foam extends through the voids of the cell cooler.

2. The battery pack frame as claimed in claim 1, wherein the top plate, the bottom plate, and the cell cooler are metal plates.

3. The battery pack frame as claimed in claim 1, wherein the top plate and the bottom plate are coupled together by at least one of welding, soldering, clinching, screwing, or bolting.

4. The battery pack frame as claimed in claim 1, wherein the top plate and the bottom plate are coupled together by the foam.

5. The battery pack frame as claimed in claim 1, wherein the top plate comprises one or more cut-outs in an area of a bottom side of each accommodation chamber of the accommodation chambers such that an upper side of the cell cooler contacts the rechargeable battery cells and a lower side of the cell cooler contacts the foam.

6. The battery pack frame as claimed in claim 1, further comprising one or more reinforcement elements installed in tie-in points of the lengthwise beams and the crosswise beams.

7. The battery pack frame as claimed in claim 1, wherein the bottom plate includes pressed features selected from the group consisting of dimple elements, trapezoid shaped ribbing, and corrugated wave shapes.

8. The battery pack frame as claimed in claim 1, wherein the cell cooler is a roll-bonding cooler.

9. The battery pack frame as claimed in claim 1, wherein the voids of the cell cooler are located underneath the lengthwise beams and the crosswise beams.

10. The battery pack frame as claimed in claim 1, wherein the foam comprises polyurethane.

11. The battery pack frame as claimed in claim 1, wherein the foam is composed of two or more materials differing in at least one of density or stiffness.

12. The battery pack frame as claimed in claim 11, wherein the space between the top plate and the bottom plate is divided into a plurality of spatially separated areas, wherein a number of the plurality of spatially separated areas is equal to a number of the two or more materials of the foam, and wherein each material of the two or more materials of the foam substantially fills one spatially separated area of the plurality of spatially separated areas in the space between the top plate and the bottom plate.

13. The battery pack frame as claimed in claim 1, wherein the cell cooler further comprises a plurality of connecting elements.

14. The battery pack frame as claimed in claim 1, wherein the foam substantially fills a space within the lengthwise beams and the crosswise beams and a space between the cell cooler and the bottom plate.

15. The battery pack frame as claimed in claim 14, wherein a portion of the foam within the lengthwise beams and the crosswise beams is connected to another portion of the foam between the cell cooler and the bottom plate through the voids of the cell cooler, and wherein the foam is a monolithic foam body above and below the cell cooler.

16. The battery pack frame as claimed in claim 1, further comprising hollow tubes embedded in the foam along outermost lengthwise beams of the lengthwise beams.

17. A battery pack comprising:
the battery pack frame as claimed in claim 1;
a plurality of rechargeable battery cells accommodated within the battery pack frame; and
a plurality of battery pack frame covers covering the accommodation chambers of the battery pack frame.

18. The battery pack as claimed in claim 17, wherein each of the plurality of battery pack frame covers is configured to maintain pressure on the rechargeable battery cells.

19. The battery pack as claimed in claim 17, wherein each of the plurality of battery pack frame covers comprise corrugations configured to form vent-gas channels over the rechargeable battery cells.

20. An electric vehicle comprising the battery pack as claimed in claim 17.
